(19) United States
(12) Patent Application Publication
(10) Pub. No.: US 2003/0140333 A1
(43) Pub. Date: Jul. 24, 2003

(54) Integration of computer system components

(75) Inventors: Toshiyuki Odaka, Campbell, CA (US); Arindam Saha, Sunnyvale, CA (US)

Correspondence Address: David T. Cunningham, Esq., Hitachi America, Ltd., 50 Prospect Avenue, Tarrytown, NY, 10591, US

(73) Assignee: Hitachi, Ltd., Tokyo (JP)

(21) Appl. No.: 10/028,045

(22) Filed: Dec. 20, 2001

(51) Int. Cl. G06F 9/44

(52) U.S. Cl. 717/115; 717/107; 717/100

(57) ABSTRACT

Integration of application programs, includes middleware, which is built by a system integrator from individual components, which are typically parameterizable, may come from disparate authors and environments, and may be used repeatably. Software build tools (for example compiler, assembler, linker, etc.) are used. A set of tags describes some parameters for software configuration. A specific configuration tool automatically reads configuration files, shows the system integrator choices, and builds the integrated program based on the system integrator's choices. In addition to configuring in a local environment, configuration may be in a distributed environment via the use of web servers and web browsers. Web browsers, which function as interfaces with the system integrator and the distributed environment, are independent of the particular components.

### BACKGROUND OF THE INVENTION

The present invention relates to the integration of two or more previously developed, that is, complete, executable application programs, by a system integrator.

There are devices to assist a software developer who writes programs, but such devices are not designed for the level of a system integrator. At the present, a system integrator works to integrate programs on a single machine. However, computer systems in general are becoming more distributed. The system integrator writes middleware to integrate a plurality of complete, executabled application programs.

In general and from the point of view of the system integrator, a computer system may be said to comprise the following:

I. APPLICATION PROGRAMS

II. MIDDLEWARE

III. OPERATING SYSTEM

IV. HARDWARE

Usually the middleware sits between two component application programs or an application program and the operating system, or in the future it may be a part of the operating system. The middleware translates information between the application programs, and/or between an application program and the operating system. Part of the computer system that includes middleware may also include an assembler, a compiler or language interpreter. The computer system could be for video conferencing

Therefore, the middleware, in relation to the needed hardware, integrates two or more components of software. Thus, the middleware provides functionality to application programs and links the application programs to the underlying hardware. Middleware calls functions to the application level and in return there is program flow to and through the middleware.

In integrating, the choice of cpu determines the assembly language or specific machine language or specific instruction set to use for the software components. The choice of application program includes the use of the assembly language chosen.

Real time features from the operating system level are provided to the middleware, so that the middleware, in addition to being separate, may be a kind of operating system or be a part of the operating system. Such real time features may includes system calls to a library of the middleware.

The hardware level provides the middleware with: memory size, machine instructions, and machine architecture, for example, levels of cache, power consumption performance related information, speed performance related information, code size, static performance related information, and dynamic performance related information.

Existing software build tools are used by software developers and designers, who could use XML (an acronym for eXtensible Markup Language) to create customized tags that offer great flexibility in organizing and presenting information.

### SUMMARY OF THE INVENTION

The present invention uses a special configuration tool to assist a system integrator interface with and use existing build tools and software databases, and also to extend system configuration to distributed environments with a web browser and markup language.

The present inventors have analyzed problems relating to integration of programs, identified and analyzed causes of the problems, and provided solutions to the problems. Integration of programs may include, for example, the building of middleware or a portion of an operating system. The analysis of the problems, the identification and analysis of the causes, and the provision of solutions are each parts of the present invention and will be set forth below.

Software configuration via the known “Makefile” has many limitations. Usage of Makefile is sometimes complicated because the user can see not only the necessary part for configuration but also the contents of the entire file. Most IDE (Integrated Developing Environment) tools, such as Microsoft Visual C++, are no exception. Makefiles and IDE tools are perhaps useful to software developers but not to system integrators. The system based on this invention bridges the gap between the system integrator and completed software.

Middleware has many requirements that should be specified as early as possible. For example, the microprocessor core to which the middleware is mapped, compiler options, real-time operating systems (RTOS), speed (response time), and whether it is software-only or hardware-only or a hybrid solution; all these may be selected by system integrators depending upon their system requirements.

The components of middleware are typically parameterizable and therefore a software configuration must accommodate these parameters in a methodical manner. The components and information relating to their parameters or configuration are not always available on the single machine which the system integrator uses for integration; instead, these components may be distributed on multiple networked machine systems.

Middleware requirements have some similarity to the requirements of modern System-on-Chips (SoCs), which involve integration of multiple functions on a single computer chip. Just like a SoCs, the individual middleware components come from disparate authors and environments, and should ideally be reused again and again.

Presently, in some cases, a programmer uses techniques like pragmas, for example, #if, #ifdef, #else, #elif and #endif, to partition code, whereas in some other cases the programmer creates separate files for every condition. This makes a more complicated configuration process for system integrators, makes the middleware inflexible and difficult to scale, and restricts one to a stand-alone machine. Pragmas are directives to the preprocessor of a C compiler and could be said to be conditional compilation directives.

The present invention relates to middleware that is built by a system integrator to integrate application software components, some or all of which are thereby optimized for some target hardware.

There is a need for simplification of software configuration in the process of integration. Present day techniques of integrating are not only complicated, but have been conceived by and for software developers only, without paying adequate attention to system integrators. But it is the system integrator, not the software developer, who has maximum use of software configuration systems. The problem solving portion of the invention sets out to alleviate this identified problem by addressing and analyzing the identified causes.

In addition, due to the proliferation of the Internet, software integration is no longer limited to a stand-alone machine. More and more, the components being integrated reside in a distributed environment connected both by local area networks (LANs) and wide area networks (WANs). Current software configurations lack the capability of handling distributed components. An embodiment of the present invention alleviates this problem.

The embodiment uses a software configuration system having a specific configuration tool and a software database. The embodiment utilizes existing software build tools (e.g. compiler, assembler, linker, translator, etc.), existing interface languages such as XML, existing web servers and existing web browsers, all of which are available and well known. These components may be distributed, for example, connected by a computer network environment, or they may be localized.

Configuration files (files that contain machine-readable operating specifications for a piece of hardware or software, or files that contain information on parameters of components) stored in software databases are written in an existing language according to the embodiment, which is preferably XML (extensible Markup Language). This embodiment includes a set of tags in XML used to describe parameters for software configuration, called herein Software Configuration Markup Language (SCML), which comprises two types of configuration files: 1) configuration files for each individual module, that is, component, and 2) configuration files for a whole program (or middleware), like Makefile, an existing method of software configuration.

A specific configuration tool included in the embodiment uses script that automatically reads the configuration files in the SCML tag set, shows the system integrator some choices, selects other choices based on the system integrator's choices, shows such other choices to the system integrator to make additional choices, and builds software based on the system integrator's choices.

XML is used because it is flexible and extensible. A key advantage of using XML in the embodiment is the ability to configure in a distributed environment via the use of common web browsers as interfaces between distributed resources and to interface with the system integrator. Thereby, the interfaces are independent of the particular components.

### BRIEF DESCRIPTION OF THE INVENTION

The present invention is illustrated by way of a preferred embodiment, best mode and examples, which do not define by way of limitation. Further objects, features and advantages of the present invention will become more clear from the following detailed description of a preferred embodiment and best mode of implementing the invention, as shown in the figures of the accompanying drawing, in which like reference numerals refer to similar elements, wherein:

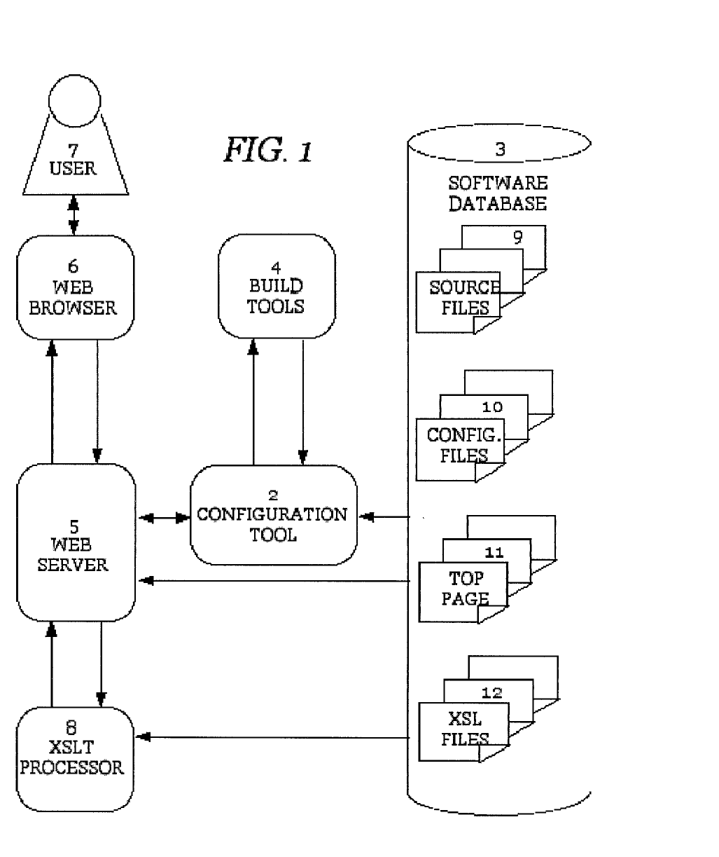

FIG. 1 shows a hardware and software configuration system embodiment, according to the present invention;

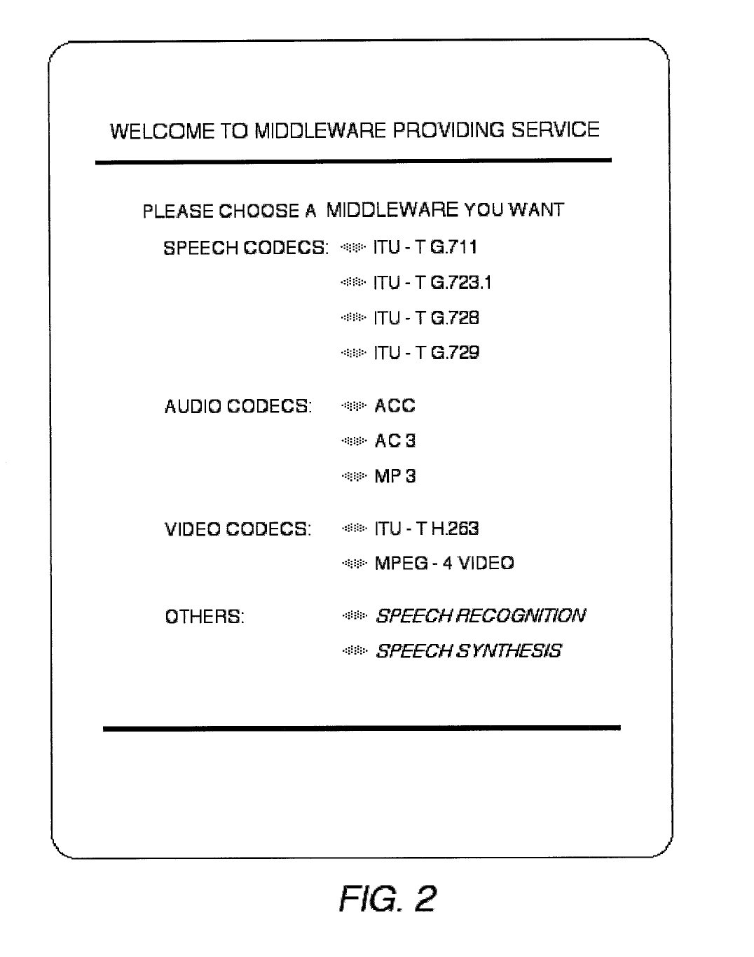

FIG. 2 is an example display of a web page for assisting the system integrator in choosing components during system integration and the building of a desired middleware;

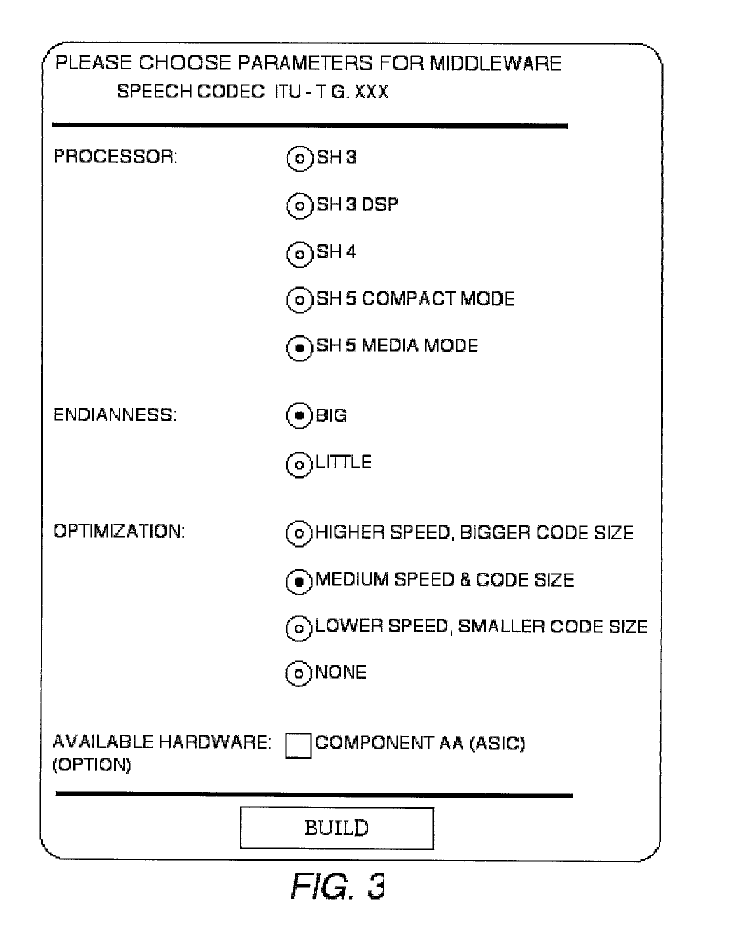

FIG. 3 is an example display of a web page for assisting the system integrator in making further choices for setting parameters of components for integration;

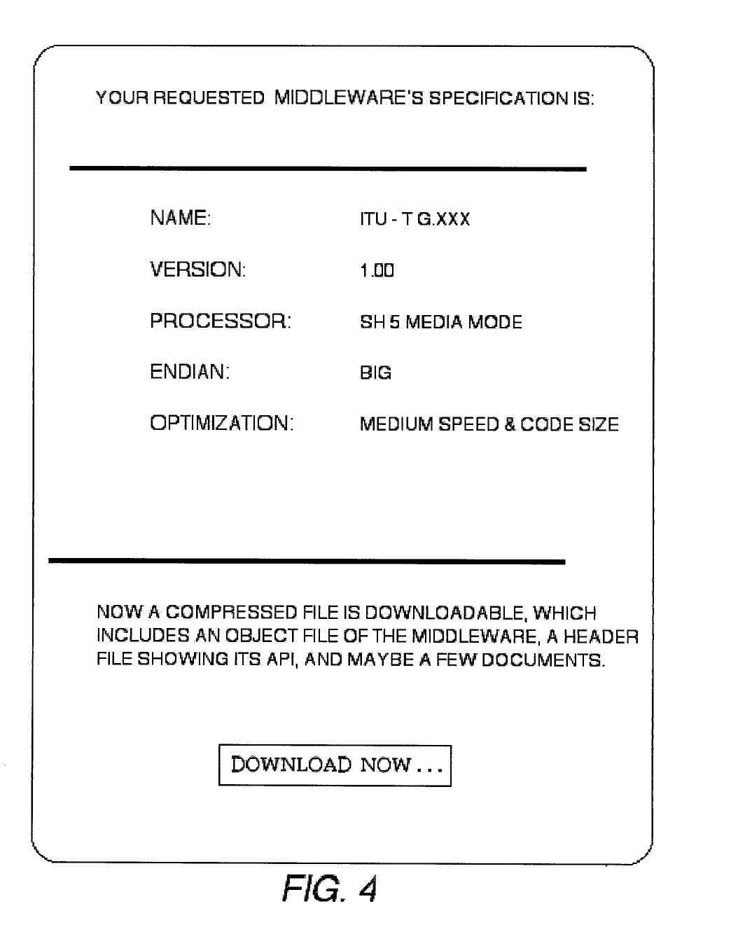

FIG. 4 is an example display of the configured middleware based upon the system integrator choices, ready to be downloaded and built when the system integrator makes a confirmation;

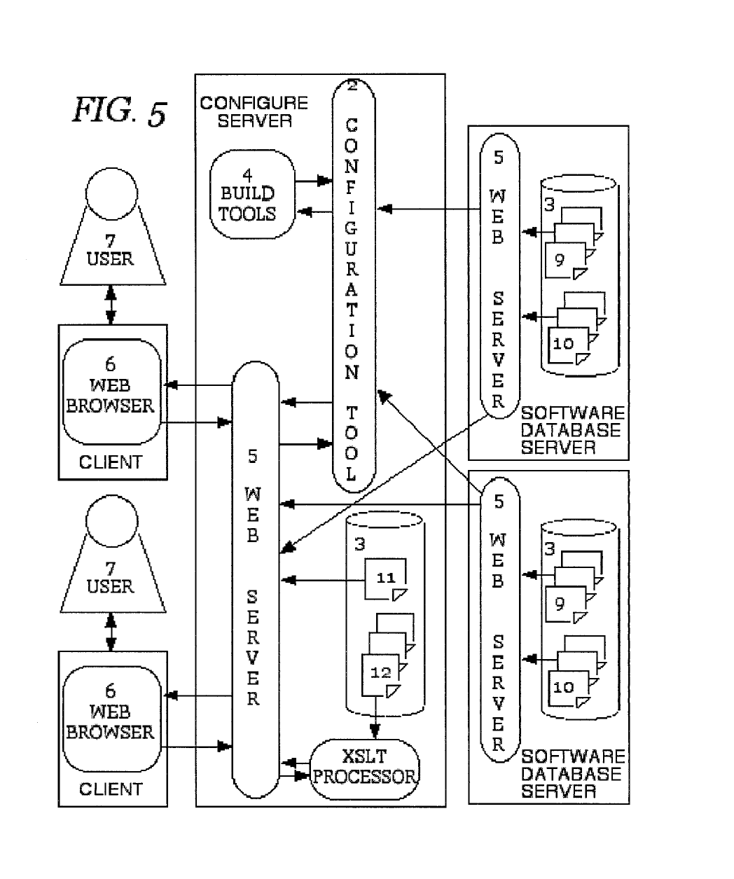

FIG. 5 shows a distributed hardware and software configuration system as an extention of the embodiment of the present invention into a destributed environment;

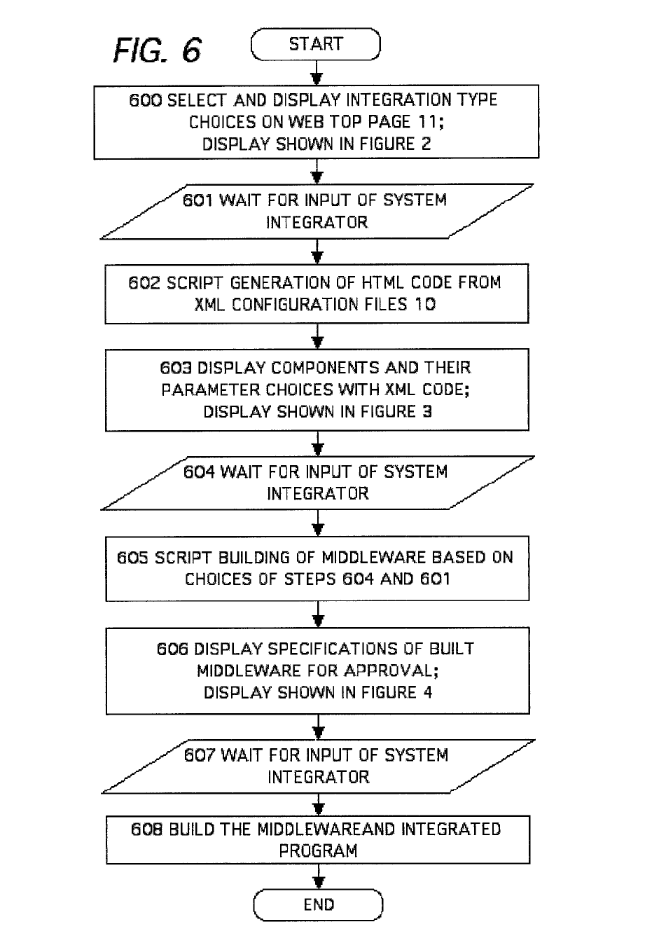

FIG. 6 is a flowchart of an embodiment of a process and operation of a computer system for producing middleware and integrating components by interfacing with the system integrator; and

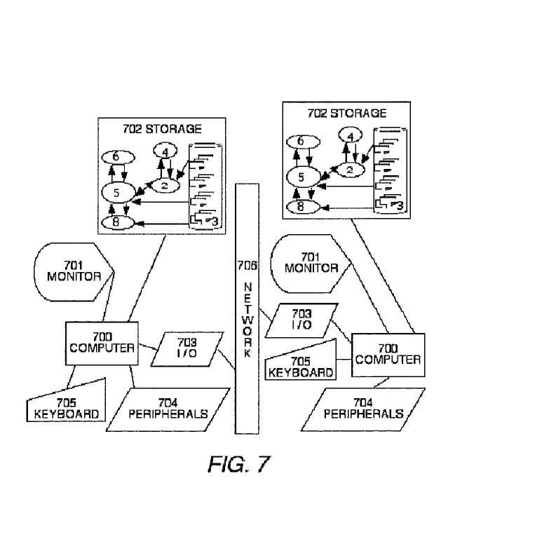

FIG. 7 shows another distributed hardware and software configuration system as an extention of the embodiment of the present invention into a destributed environment.

### DETAILED DESCRIPTION

The embodiment is described as system, method, hardware, computer media and software, with a special configuration tool, to assist a system integrator interface with and use existing build tools and software databases, and also to extend system configuration to distributed environments with a web browser and markup language.

In the following description, for the purposes of explanation, numerous specific details are set forth in order to provide a thorough understanding of the broader aspects of the present invention, as well as to appreciate the advantages of the specific details themselves according to the more narrow aspects of the present invention. It is apparent, however, to one skilled in the art, that the broader aspects of the present invention may be practiced without these specific details or with equivalents determined explicitly herein or in accordance with the guidlines set forth herein. Well-known structures and devices are shown in block diagram form in order to avoid unnecessarily obscuring the present invention with unnecessary details of well known technology.

Still other aspects, features and advantages of the present invention are readily apparent from the following detailed description illustrating a particular implementation, including the best mode contemplated by the inventor. The present invention is also capable of other and different embodiments, and its several details can be modified in various respects, all without departing from the spirit and scope of the present invention. The drawing and description are illustrative and not restrictive.

FIG. 1 shows a hardware and software outline of the configuration system 1 of an embodiment, according to the present invention, which has a configuration tool 2, a software database 3, conventional software build tools 4, a known web server 5, one or more known web browsers 6 for interface with the system integrator 7, and a known XSLT processor 8.

The configuration tool is implemented with script, according to the disclosed operation herein, for example in Common Gateway Interface (CGI) or Active Server Pages (ASP), which is well within the skill of one of ordinary skill in the arts of this invention. The configuration tool 2 reads the configuration files in SCML and uses the build tools 4, to build software based on the choices of the system integrator 7 (from among those represented in the configuration files 10, for example, refered to below). It is contemplated that the configuration tool 2 or a part of it is combinable with or is a part of existing IDE's (an acronym for Integrated Developement Environment). IDEs are integrated tools generally run from one interface and they include a compiler, an editor and a debugger, e.g., usually for developing software.

All or one or more subsets of these components 2-8 may be distributed over one or more networks, that is they may be in a distributed environment as is shown in FIG. 5 and FIG. 7.

XSL is an acronym for Extensible Style/Stylesheet Language, which can apply formatting to complex XML data for presentation to more than one type of object, for example display objects. XSL includes an XML vocabulary for specifying formatting and styling for an XML document. XSLT refers to XSL Transformations, that is the transforming of XML documents into other XML documents (for example HTML documents). An XSLT processor is a tool that performs such transformations.

Source or component files 9 (completed executable programs), configuration files 10 in XML (having information such as specifications and parameters of components), a web page 11 written in HTML or XML (as a template or the like for displaying information), and XSL files 12 are stored in the software database 3.

The key components of the configuration files 10 include the SCML tags and script. Software developers should create these configuration files 10 at the time they develop their software, and the configuration files 10 are then stored in the software database 3. In some cases, the configuration files are automatically generated from source or component files and Makefiles according to the invention.

The configuration and integration steps of an embodiment of a process and operation of a computer system for producing middleware and for integrating components by interfacing with the system integrator are set forth in the flowchart of FIG. 6, with reference to other figures.

Step 600, selects plural choices of the type of integration, for example choices of speech codecs, audio codecs, video codecs, speech recognition and speech synthesis. These choices are read from the files by script (a program consisting of a set of instructions to customize and provide interactivity with the system integrator). More particularly, the information to generate the choices is obtained via the web browser 6, web server 5 and script of the configuration tool 2 from the component files 9 and configuration files 10, of FIG. 1. The read choices are then provided as a part of hardware specifications to the system integrator by using a web page 11 and XSL files 12. Preferably, the choices are provided by display as shown in FIG. 2 on a monitor, such as the monitor 701 of FIG. 7.

Step 601 waits for the system integrator 7 selection of the relevant middleware choices from the display of FIG. 2, which display is controlled by step 600. FIG. 2 is an example display of one web page for assisting the system integrator in choosing application type, components and parameters of components during system integration and the building of a desired middleware. The web browser 6 acts as the system integrator interface with the computer system, and the system integrator selection is made by the system integrator clicking on appropriate link areas. In the web page of FIG. 2, the link areas are shown as shaded ovals adjacent the selections.

Step 602, responds to the system integrator input from step 601, and the choices of such input invoke script. The script of the configuration tool 2 in turn generate corresponding HTML code from some of the XML-based configuration files 10, which are more specifically in SCML for selecting and generating plural choices of components and their parameter choices to be used for integration of a plurality of completed source or component executable programs, particularly a plurality of application programs.

Step 603 displays, as shown in FIG. 3, plural choices of components and their parameter choices, which display is generated in HTML code in step 602. FIG. 3 is an example display of a web page for assisting the system integrator in making further choices. More specifically, the FIG. 3 displayed web page is generated using a format of the web page 12, to assist the system integrator in chosing the components and in the setting of their parameters. Three preliminary choices are indicated as having been made by the system integrator, by the darkening of the center of each of the corresponding link symbols in the display of FIG. 3.

Step 604 waits for the system integrator to finish making the choices that are displayed in Step 603. The system integrator indicates the choices have been made by using a trigger, e.g., clicking the “BUILD” button on the web page of FIG. 3.

Step 605, in response to the input from step 604, invokes some more script and executes the invoked script to build the middleware. The script of the configuration tool 2 in turn generates corresponding HTML code from some of the XML-based configuration files 10, which are more specifically in SCML, for selecting and generating a middleware specification corresponding to the choices of integration type, components and component parameters to be used for integration of the plurality of completed executable programs. More particularly, the information to generate the middleware specifications is obtained via the web browser 6, web server 5 and script of the configuration tool 2 from storage, as shown in FIG. 1.

Step 606 provides, to the system integrator 7, the middleware specifications that were generated in step 605. Preferably, the middleware specifications are provided by displaying via a web page 11 as shown in FIG. 4, on a monitor 701 of FIG. 7.

Step 607 waits for the system integrator 7 to approve the specifications of middleware, displayed in step 606. Approval is by the system integrator 7 clicking the “DOWNLOAD NOW . . . ” button in the display of FIG. 4, as shown on the monitor 701 of FIG. 7.

Step 608, in response to the system integrator input from step 607, invokes script of the configuration tool, which then downloads completed executable programs that are to be integrated, if the components have not already been downloaded in preceeding steps, for example in step 605 and/or step 602. The components downloaded are determined by, that is dependent upon, the choices made by the system integrator. Execution of the script utilizes existing build tools 4, to build the middleware that integrates the completed executable programs based on the choices, including those choices that determine the middleware type, choose components and set the parameters, which choices are made by the system integrator. Thereby the system integrator is assisted by the computer system in building the integrated application programs or middleware in dependence upon the received choices from steps 601, 604 and 607.

The following EXAMPLE 1 is taken from the beginning portion of an example configuration file 10 of FIG. 1, which in the particular example, generates the display of FIG. 2, according to step 600 of FIG. 6:

### EXAMPLE 1

:
:

```
<MIDDLEWARE>
  <CATEGORY>Speech Codecs</CATEGORY>
  <NAME>ITU-T G.XXX</NAME>
  <VERSION> 1.00</VERSION>
  <RELEASEDATE>
    <YEAR>200 1</YEAR><MONTH>5</MONTH><DAY> 11</DAY>
    </RELEASEDATE>
  <AUTHOR>XYZ, Ltd. R&D Div.</AUTHOR>
  <COPYRIGHT> XYZ, Ltd.</COPYRIGHT>
```

:
:

The following EXAMPLE 2 is of an example configuration file 10 of FIG. 1, which in the particular example, generates the display of FIG. 3, according to steps 602 and 603 of FIG. 6:

### EXAMPLE 2

```
<CHOICES type=“PROCESSOR” option=“cpu”>
  <ITEM option_value=“sh3”>CPU3</ITEM>
  <ITEM option_value=“sh3dsp”>CPU3D SP</ITEM>
  <ITEM option_value=“sh4”>CPU4</ITEM>
  <ITEM option_value=“sh5c”>CPU5 COMPACT MODE</ITEM>
  <ITEM option_value=“sh5m”>CPU5 MEDIA MODE</ITEM>
</CHOICES>
<CHOICES type=“ENDIANNESS” option=“endian”>
  <ITEM option_value=“big”>BIG ENDIAN</ITEM>
  <ITEM option_vlaue=“little”>LITTLE ENDIAN</ITEM>
</CHOICES>
<CHOICES type=“OPTIMIZATION”>
  <ITEM option=“speed”>HIGHER SPEED, BIGGER CODE SIZE</ITEM>
  <ITEM option=“nospeed”>MEDIUM SPEED & CODE SIZE</ITEM>
  <ITEM option=“size”>LOWER SPEED, SMALLER CODE SIZE</ITEM>
</CHOICES>
<INTERFACE type=“FILE”>gXXXapi.h</INTERFACE>
<COMPONENT_LIST>
```

<COMPONENT

type=“NAME”>XXX_TOP_COMPONENT</COMPONENT>

<COMPONENT type=“NAME”>COMPONENT_AA</COMPONENT>
<COMPONENT type=“NAME”>COMPONENT_BB</COMPONENT>
<COMPONENT type=“NAME”>COMPONENT_CC</COMPONENT>
<COMPONENT>

<NAME>COMPONENT_DD</NAME>
<CHOICES>
...... .........
</CHOICES>

</COMPONENT>
</COMPONENT_LIST>
</MIDDLEWARE>

:
:

The above example 1 and example 2 configuration files 10 are for specifying part of a complete middleware program. The MIDDLEWARE tag represents the highest layer and contains a variety of tags including a CATEGORY tag, a NAME tag, a VERSION tag, RELEASEDATE tag, an AUTHOR tag, a COPYRIGHT tag, any number of CHOICES tags, an INTERFACE tag, and a COMPONENT LIST tag. There are shown three types of CHOICES—processor, endianness and optimization (optimization levels), where the number of choices in this particular example are five, two and three (not counting NONE as a choice), respectively.

Endianness means the order in which the bytes of a value larger than one byte are stored in memory. For example, endianness affects integer values and pointers, while arrays of single-byte characters are not affected. Endianness depends on the hardware, particularly the processor choice (CPU). There are most commonly two types of endianness: (1) little endian machines store the least significant byte on the lowest memory address, so that the word is stored little-end-first; and (2) big endian machines store the most significant byte on the lowest memory address, so that the word is stored big-end-first. Some processors can run in big endian or little endian mode. Some machines may selectively operate as a little endian machine or a big endian machine.

Optimization is a process run in step 605 for more efficiently integrating programs, with respect to code size and execution speed of the middleware type and components chosen in step 601 and step 604 from the displays of FIG. 2 and FIG. 3, through selection and design of data structures, algorithms and instruction sequences. Optimization choices determine the process of the system compiler or assembler in producing efficient executable code. For example, optimization is obtained with an optimizing compiler that, in response to a chosen optimization from the FIG. 3 display (step 604 ), prepares the completed executable programs downloaded according to step 605 or step 608 to run efficiently on the processor chosen in step 604.

The type attribute is used to indicate types of middleware (from FIG. 2), processor, endianness, optimization, RTOS (Real-Time Operating System) that is not exemplified in the code, etc. (from FIG. 3). The ITEM tags in CHOICES represent the labels displayed on the web browser as choices, FIG. 3 in the example. The option attribute and the option_value attribute are used for setting options for compiling or assembling. The INTERFACE tag includes some documents that explain the API (Application Programming Interface) of the middleware and is optional. The document can simply be a header file that defines some interface functions and other public information. The COMPONENT LIST consists of some components that can be represented by either their names or XML structures.

Below, in EXAMPLE 3, there is shown an example configuration file 10 of FIG. 1, for a component. This configuration file is processed by the script of the configuration tool 2 in FIG. 6, as a part of the middleware building step 605:

### EXAMPLE 3

:
:

```
<COMPONENT>
  <NAME>COMPONENT_AA</NAME>
  <INTERFACE type=“file”>componentAA.h</INTERFACE>
  <CHOICES>
```

<IMPLEMENT type=“SOFT_ONLY”>

<ITEM>CPU3</ITEM>
<SOURCE type=“C_FILE”

define=“CPU3”>componentAA.c</SOURCE>

</IMPLEMENT>
<IMPLEMENT>

<ITEM>CPU3D SP</ITEM>
<SOURCE type=“C_FILE”

define=“CPU3DSP”>componentAA.c</SOURCE>

<SOURCE type=“ASM_FILE”>componentAAsh3dsp.asm</SOURCE>

</IMPLEMENT>
<IMPLEMENT>

<ITEM>CPU4</ITEM>
<SOURCE type=“C_FILE”

define=“CPU4”>componentAA.c</SOURCE>

<SOURCE type=“ASM_FILE”>componentAAsh4.asm</SOURCE>

</IMPLEMENT>
<IMPLEMENT>

<ITEM>CPU5 COMPACT MODE</ITEM>
<SOURCE type=“C_FILE”

define=“CPU5COMPACT”>componentAA.c</SOURCE>

</IMPLEMENT>
<IMPLEMENT>

<ITEM>CPU5 MEDIA MODE</ITEM>
<SOURCE type=“C_FILE”

define=“CPU5MEDIA”>componentAA.c</SOURCE>

</IMPLEMENT>
<IMPLEMENT>

<ITEM>ANY_PROCESSOR<ITEM>
<SOURCE type=“C_FILE”>componentAA.c</SOURCE>

</IMPLEMENT>
<IMPLEMENT type=“HARD_DRIVER”>

<ITEM>ASIC</ITEM>
<SOURCE type=“C_FILE”>componentAAasic.c</SOURCE>
</IMPLEMENT>

<CHOICES>

</COMPONENT>

:
:

In the above example 3 configuration file 10, for an individual component that is part of the whole program, the COMPONENT tag represents, just like that of the whole program, the highest layer and includes a NAME tag, an INTERFACE tag, and a CHOICES tag. The representation “AA” is a specified processor. Several IMPLEMENT tags are included in the CHOICES tag. The SOURCE tags show the source or component file name with a “type” attribute representing source or component type (one can include the source or component code itself as part of this configuration file if necessary). The “define” attribute corresponds to the values in the conventional #define directive (or compiling option, such as −define=value or −Dvalue) needed by compile preprocessors.

Below, in EXAMPLE 4, there is shown an example C source code file 11, which is partitioned for some processors. This source file should be processed through the configuration tool 2 by the compiler that is one of the build tools, as a part of the middleware building step 605 of FIG. 6:

### EXAMPLE 4

:
:

| | |
|---|---|
| #if defined | CPU3 DSP |
| int function( ) | /* optimized for CPU3DSP*/ |
| { | |

:
:

| | |
|---|---|
| } | |
| #elif defined | CPU4 |

| | |
|---|---|
| int function( ) | /* optimized for CPU4*/ |
| { | |

:
:

| | |
|---|---|
| { | |
| #elif defined | CPU5COMPACT |

| | |
|---|---|
| int function( ) | /* optimized for CPU5 compact mode */ |
| { | |

:

| | |
|---|---|
| { | |
| #elif defined | CPU5MEDIA |

| | |
|---|---|
| int function( ) | /* optimized for CPU5 media mode */ |
| { | |

:
:

| | |
|---|---|
| } | |
| #else | |
| int function( ) | /* not optimized for any specific processor */ |
| } | |

:
:

}
#endif

:
:

In the above example 4 of C source or component code, “componentAA.c”, is commonly used for several processors. The contents of this component configuration file (COMPONENT) can be included in the MIDDLEWARE definition file such as COMPONENT_DD in the example 2 configuration file 10, above. For easier maintenance it is better to create separate files for components. It is also recommend that the program source or component code be maintained in separate files.

The extensibility feature of XML, or a like language, is particularly useful for configuring in a networked or distributed environment, as a part of the system for integrating. Such a distributed environment is shown in FIGS. 5 and 7, where the elements have already been described with respect to FIG. 1. In the embodiment, the software database server of FIG. 5 is conventional. The networking is apparent from the couplings shown in the drawing, where the following components may be local or at distant locations coupled by a network, such as a LAN or WAN: system integrators 7; clients; configure server; and software database servers. That is, the components may each be independent of the physical location of the other individual components.

Thus, a key advantage of this invention is the ability to configure middleware in a distributed environment, such as the distributed environment of FIGS. 5 and 7, which shows how a system integrator configures with a configure server machine, one or more client machines, and one or more software database server machines, all distributed in a networked environment. For example, each of the software developing sections (configure server in the FIG. 5 embodiment, for example) administers separate software database server machines to maintain and revise their corresponding software in a timely and structured manner.

There are various ways this invention can be put to use. It can provide middleware to sales people (for example sales and management people) in a company and to any of its customers, related to functions like sales, billing and security. An immediate use of this invention is to streamline the middleware development activity spread over different groups in diverse geographical locations in a large worldwide company. This invention can transform the middleware development by emphasizing reuse of preverified components authored by different groups, that is completed executable programs, as components to build an integrated program, thus enabling the system integrator to focus on system issues as opposed to details of components.

Computer readable media to carry code for imnplementing the integration method, according to the embodiments, refers to any medium that participates in providing code, for example the script, according to the invention to a processor for execution. Examples include non-volatile media or volatile media. Non-volatile media includes, for example: optical or magnetic flexible discs or tapes and hard disks, and more specifically CD-ROM, CDRW and DVD; and punch cards, paper tape, optical mark sheets or any other physical medium with patterns of holes. In general computer readable media as used herein includes any physical fixation, temporary or more permanent, from which a computer can read code.

Transmission lines of the embodiments include coaxial cables, copper wire, wireless links and fiber optics, which may send acoustic, optical or electromagnetic waves, such as those generated during radio frequency (RF) and infrared (IR) data communications.

While the present invention has been described in connection with a number of embodiments, implementations, modifications and variations that have advantages specific to them, the present invention is not necessarily so limited, but covers various obvious modifications and equivalent arrangements according to the broader aspects, all according to the spirit and scope of the following claims.

What is claimed is:

1. A method performed by a machine interfacing with a system integrator, for integrating a plurality of completed executable programs as components to build an integrated program, comprising the steps of:
invoking script for selecting and generating plural choices of components and choices of their parameters to be used for integration of the plurality of completed executable programs;
providing to the system integrator the choices of components and their parameter choices;
receiving choices of components and their parameters from the system integrator; and
thereafter, building the integrated program from the completed executable programs in dependence upon the received choices.

2. The method of claim 1, further comprising:
providing to the system integrator configuration information based upon the choices;
requesting confirmation of the displayed configuration information from the system integrator; and
performing said step of building in response to receiving system integrator confirmation.

3. The method of claim 2, wherein:
each of said steps of providing include displaying the respective choices to the system integrator.

4. The method of claim 3, wherein:
each of said steps of providing, requesting and receiving include interfacing with the system integrator through a web browser with a markup language.

5. The method of claim 3, wherein:
each of said steps of selecting include two way communicaion via a web browser over a network with storages in a distributed environment.

6. The method of claim 5, wherein:
each of said steps of selecting includes generating corresponding ones of the choices in a markup language from configuration files obtained from the storages in the distributed environment.

7. The method of claim 1, wherein:
said step of selecting includes two way communicaion via a web browser over a network with storages in a distributed environment.

8. The method of claim 7, wherein:
said step of generating includes generating corresponding ones of the choices in a markup language from configuration files obtained from the storages in the distributed environment.

9. The method of claim 7, further including:
selecting plural choices of the types of integration to be performed by the integrated program;
providing to the system integrator the plural choices of types of integration to be performed;
receiving choices from the system integrator from among the choices of types of integration to be performed; and
downloading the complete executable programs in dependence upon received choices of types of integration.

10. The method of claim 1, further comprising:
providing to the system integrator an indication of choices made by the system integrator and choices not made by the system integrator and requesting confirmation; and
thereafter, in response to receiving system integrator confirmation, performing said step of building the integrated program.

11. The method of claim 1, wherein:
each of said steps of selecting include retrieving from storage script that reads configuration files and invoking the script to perform said gnerating; and
said step of building includes retrieving from storage and invoking script and build tools.

12. The method of claim 1, wherein:
said step of providing to the system integrator plural choices, presents choices of microprocessor cores to which the plurality of completed executable programs are to be mapped, compiler choices, assembly choices, real-time operating system choices, speed choices, and choices of parameters for components of the integrated program including configuration information of performance, power consumption and code size.

13. The method of claim 1, wherein:
said step of selecting includes retrieving from storage script that reads configuration files and executing at least some of the script for retrieving from storage markup language code that describes configuration files for use by said step of providing.

14. The method of claim 13, wherein:
said step of selecting includes storing the configuration files in a distributed environment.

15. The method of claim 1, wherein:
said step of providing to the system integrator plural choices and said step of receiving are each conducted for choices of media type, processor identification, optimization level, and endianness.

16. A configuration tool for use in a computer system and for interfacing with a system integrator in integrating programs, said configuration tool comprising:
storage media having physical implementation of code for performing the method of claim 1.

17. A configuration tool for use in a computer system and for interfacing with a system integrator in integrating programs, said configuration tool comprising:
storage media having physical implementation of code for performing the method of claim 3.

18. A configuration tool for use in a computer system and for interfacing with a system integrator in building an integrated program, said configuration tool comprising:
storage media having physical implementation of code for performing the method of claim 5.

19. A configuration tool for use in a computer system and for interfacing with a system integrator in integrating programs, said configuration tool comprising:
storage media having physical implementation of code for performing the method of claim 6.

20. A configuration system comprising the configuration tool of claim 16, for operation in a distributed environment, the system further comprising:
at least one computer coupled to said configuration tool;
a web browser coupled to said computer and said configuration tool for interfacing with the system integrator and with said storage media for the steps of selecting and receiving;
a display coupled to said web browser for interfacing with the system integrator for the step of providing;
said storage media being in a distributed environment and having physical implementation of configuration files of component specifications in machine-readable form, and containing machine-readable component files for said plurality of completed executable programs;
said storage media further having physical implementation of machine-readable display page formats for interfacing with the system integrator during the steps of providing and receiving; and
software build tools coupled to said configuration tool.

21. The configuration system according to claim 20, wherein
said configuration files are of media type, processor cores to which executable programs are to be mapped, compiler and assembly options, real-time operating systems, speed optimization levels, and parameters of the plurality of completed executable programs; and
said storage media stores physical implementations of said page formats in a markup language for choices of media type, processor cores, speed optimization levels, and parameters of the plurality of completed executable programs.

22. A configuration tool for use in a computer system having configuration files and interfacing with a system integrator in integrating programs from a plurality of completed executable programs, said configuration tool comprising:
means for reading configuration files in response to input of system integrator commands;
means for describing read configuration files as configuration choices to the system integrator;
means for formatting and for presenting to the system integrator configuration data for the integrated program, and for requesting confirmation of the configuration data;
means for controlling downloading of the plurality of completed executable programs from storage and corresponding to system integrator choices; and
means for building the integrated program from the components, in response to receiving system integrator confirmation.

23. A configuration system comprising the configuration tool of claim 22, for operation in a distributed environment, the system further comprising:
at least one computer coupled to said configuration tool;
storage media having physical implementation of display page formats for interfacing with the system integrator;
software build tools coupled to said configuration tool; and
a web browser coupled to said computer and said configuration tool for interfacing with the system integrator and with storage media in a distributed environment.

24. The configuration system according to claim 23, further including:
storage media having physical implementation of at least some of the configuration files in a markup language.

25. The configuration system according to claim 24, further including:
storage media having physical implementation of script physically implementing a method of reading configuration files in response to input of choices from the system integrator.

26. The configuration system according to claim 23, further including:
storage media having physical implementation of script physically implementing a method of reading configuration files in response to input of choices from the system integrator.

27. The configuration system according to claim 22, wherein
said means for controlling downloading communicates with the storage in a distributed environment.
